(19) United States
(12) Patent Application Publication
(10) Pub. No.: US 2010/0202883 A1
(43) Pub. Date: Aug. 12, 2010

(54) Advanced vertical shaft wind turbine power generator

(76) Inventors: Joseph A. Daley, III, Jupiter, FL (US); Joseph A. Daley, JR., Hobe Sound, FL (US)

Correspondence Address: Joseph A. Daley III, 19030 Talon Way, Jupiter, FL, 33458, US

(21) Appl. No.: 12/587,606

(22) Filed: Oct. 9, 2009

Related U.S. Application Data
(63) Continuation-in-part of application No. 12/322,833, filed on Feb. 9, 2009, now abandoned.

(51) Int. Cl. F03D 7/06; F03D 3/06

(52) U.S. Cl. 416/140; 416/131

(57) ABSTRACT

A design for a scalable advanced design vertical shaft wind turbine power generator which incorporates a superior symmetrical blade configuration and a unique blade mounting approach which utilizes aerodynamic forces to provide wide changes in blade positions o optimize efficiency and eliminates the need for expensive mechanical control devices while minimizing manufacturing, operational and maintenance costs.

### FEDERALLY SPONSORED RESEARCH

Not Applicable

### SEQUENCE LISTING OR PROGRAM

Not Applicable

### FIELD OF THE INVENTION

The present invention relates generally to a vertical shaft turbine which produces wind generated power. More particularly, the present invention relates to an arrangement which captures wind determined turbine blade position to optimize output and minimize manufacturing cost and control complexity.

### BACKGROUND OF THE INVENTION

The current carbon based fuels used in combustion systems to generate the greatest percentage of electrical energy in the United States are considered detrimental to the environment and therefore, to human life. Much effort has been directed to the direct application of sun and wind energy to replace the current fossil fuel fired electrical generation systems. Due to inefficiencies in the current art of vertical and horizontally shafted turbines the practice is to use progressively larger propeller driven generators. These have increasingly complex and expensive controls and actuation systems which has raised technical and operational concerns. Using progressively larger propeller systems with individual blades now reaching as long as one hundred fifty feet lengths has demonstrated high manufacturing cost, quality control issues in the manufacturing process and reliability issues due to stresses generated by high cycle and low cycle fatigue.

The current design art for horizontally shafted turbines requires electronically controlled blade position, rotational speed monitoring, wind direction monitoring, wind speed monitoring and nacelle orientation towards wind direction.

The current state of the design art for horizontally shafted turbines requires complex blade geometry that incorporates airfoil shapes that twist and taper from root to tip generating stresses that are difficult to minimize at continuously changing wind velocities.

The current state of the design art for vertically shafted turbines either incorporate fixed blade position or requires complex controlled blade position.

The current state of the design art for horizontal turbines incorporate either flat plate blades or traditional airfoil shapes with a bulbous leading edge to a fine tapered trailing edge.

The current state of the design art of blades for horizontal/turbines incorporate a wide base connecting to a hub and taper to a narrow blade tip.

The current state of the design for vertically shafted turbines incorporate blade position which if variable rotate on an axis about the centerline of the blade.

The current state of the design for vertically shafted turbines incorporate blade position for which either the concave or convex side of the blade always face the drive shaft with at most enabling only small (0 to 15 degrees) variation about its centerline axis in blade position with respect to the drive shaft.

An alternative to the current approach to capturing wind energy must be developed, preferably by providing a simplified design. An improved device to drive a generator must be a simple aerodynamic configuration without the requirement for complex actuation and control systems. The system must optimize wind capturing efficiency, must be cost effective to manufacture, must be affordable to maintain and must be of a configuration that does not require mechanically controlled orientation with respect to the direction of the wind.

This invention incorporates the use of a common blade cross section for the length of the blade to minimize stresses.

This invention incorporates an airfoil which is a symmetrical about the chord (new corrected spelling) which is an arc.

This invention incorporates blade rotation enabling up to 90 degrees variation in blade position with respect to the drive shaft by the locating the axis of blade rotation away from the centerline of the blade.

This invention incorporates the use of a blade positioning channel enabling up to 90 degrees variation in blade position with respect to the drive shaft.

This invention permits the blades to self select the most effective position to provide wind capture in the downwind mode of rotation and minimizes drag in the upwind mode providing the maximum generation of net power and enabling operation without the need for mechanical or electrical controls.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention to include application of the invention as a water turbine. It is important, therefore, that the claims be regarded as including such equivalent constructions insofar as they do not depart from the spirit and scope of the present invention.

### SUMMARY OF THE INVENTION

The configuration necessary to provide for the advanced vertical wind turbine generator design consists of a vertical wind turbine support structure which is mounted to a supporting foundation structure. On the vertical wind turbine support structure is mounted a turbine drive shaft external drive shaft bearing within which a turbine drive shaft rotates and is connected to a drive shaft coupling which connects to an external power converter. The lower disk rotates upon the vertical wind turbine support structure on lower disk rotation bearing(s) which may be located on the perimeter or underneath the lower disk. The lower disk has blade angle rotation limiters which can be a channel or protruding stop mounted to the lower disk which controls maximum/limited blade angle rotational travel. The advanced vertical wind turbine generator utilizes multiple turbine blades which incorporate uniform blade cross section geometry from top to bottom over the full length of the blade to provide a robust structure and reducing torsion stresses found in conventional wind turbine blade designs. These turbine blades are mounted to the lower disk through blade pivot bearings which are installed on the upper and lower ends of each blade. If a blade angle channel configuration is used to limit rotation, a follower pin or a follower bearing can be mounted on the bottom and or the top of the blades opposite the blade edge which supports the blade pivot bearings to self-limit freedom of rotation to allowable positions. The blades are sandwiched between the lower disk and an upper disk through the blade pivot bearings. The upper disk may or may not have blade angle rotation limiters depending on the size and loads on the structure. The turbine drive shaft may be supported above the upper disk with a vertical shaft turbine external support structure which is mounted back to the foundation structure. The resulting configuration enables the turbine blades to self adjust their angles to optimum positions through 360 degrees of disk rotation eliminating the need for external mechanical actuation required to control blade angle at a given wind direction unlike conventional vertical shaft wind turbine designs. The entire device self adjusts to shifts in wind direction eliminating the need of external mechanical actuation or wind direction monitoring devices found in conventional wind turbine designs. The resulting energy can be direct current (DC), alternating current (AC), hydraulic, pneumatic or other direct mechanical methods. Illustration shows counterclockwise rotation but geometry could be reversed to enable clockwise rotation. The invention can be made from a wide variety of materials. Vertical wind turbine power generator height, diameter, blade geometry, number of blades and blade angle variation can be tailored to particular applications.

### BRIEF DESCRIPTION OF THE DRAWINGS

FIG. 1 is a view looking down on the lower disk of the rotating assembly of this invention

FIG. 2 is a view looking down on the lower disk of the rotating assembly with the turbine blades in place

FIG. 3 (New) is a view of the individual parts of the rotating parts of the entire rotating assembly

FIG. 4 is a vertical cross section where indicated in FIG. 2 of the entire rotating assembly of this invention

FIG. 5 is a cross section of one method of mounting the rotating assembly of FIG. 3 by a vertical drive shaft turbine support structure.

FIG. 6 (New) is a view looking down on the lower disk of the rotating assembly with a method using a blade angle rotation limiter scheme which is a fixed protruding stop mounted on the disk.

FIG. 7 (New) is a view looking down on the lower disk of the rotating assembly with the turbine blades in optimum positioning to yield maximum self regulated output of the turbine and a method using a blade angle rotation limiter scheme which is a fixed protruding stop mounted on the disk

FIG. 8. (New) is a view of the individual parts of the rotating assembly with the fixed protruding stops

FIG. 9. (New) is a cross section of the entire rotating assembly of this invention with a different embodiment of blade angle rotation limiter incorporating a fixed protruding stop.

FIG. 10 (New) is a detail drawing of an individual blade with one embodiment of a fixed protruding stop and a section view of the disk that receives the blade and a fixed protruding stop.

FIG. 11 (New) is a view looking down on the lower disk of the rotating assembly with the turbine blades self regulating into an over-speed prevention position.

### DETAILED DESCRIPTION

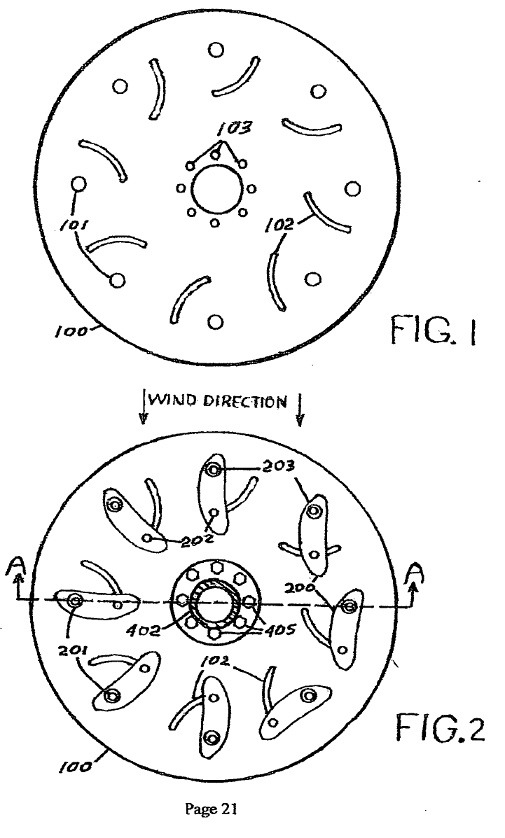

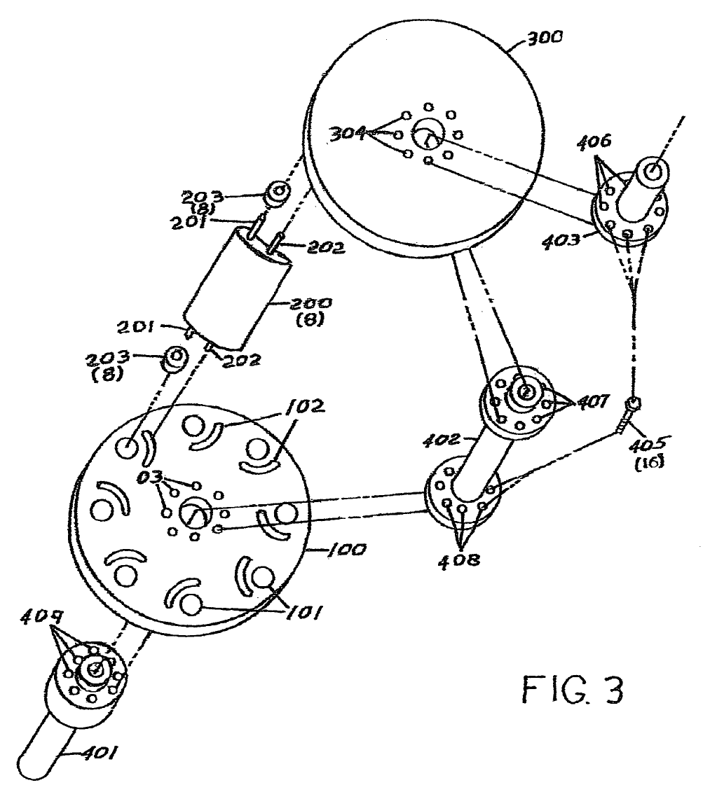

FIG. 1 The invention will now be described with reference to the drawing figures, in which the reference numerals refer to like parts throughout. The embodiment of the invention consists of a rotating assembly of aerodynamic configured blades subject to the force of the wind that will convert the rotational motion of the assembly to a force to power the driveshaft which couples to a power generator. Illustration on FIG. 1 shows the lower disk 100 configured for counter clockwise rotation, however the geometry of the disks and blade of the design could be configured in a mirror image to enable clockwise rotation. The lower disk 100 provides recesses 101 to accept the blade pivot bearings 203 identified in FIG. 2 and provides blade positioning channels 102 to accept the blade travel limiting follower pin 202 indentified in FIG. 2. Provision for assembly of the disk 100 and the lower section of the drive shaft 401 indentified in FIG. 3 and middle section of the drive shaft. 402 indentified in FIG. 3. is shown by cavities 103. In the counter clockwise rotation mode the bottom of the upper disk 302 identified in FIG. 3 is the mirror image of all the features indentified in FIG. 1.

FIG. 2 is a top down view of the lower disk 100 of the rotating assembly with eight blades 200 in place. The lower disk 100 and the bottom of the upper disk 300 identified in FIG. 3 is the mirror image. The significance of the blade aerodynamic shape and the dimensional relationship of the blade pivot bearing projection 201 and blade travel limiting follower pin 202 determines the ability of each blade to assume its most effective position in the wind stream to generate a rotational force to drive the assembly, and therefore generate the greatest system power.

FIG. 3 (New) is a view of the individual parts of the rotating assembly, The upper shaft 403 is piloted through the upper disk 300 and fastened to the middle shaft 402 through holes 304 to the middle shaft at hole locations 407 by fasteners 405. The middle shaft 402 is piloted through the lower disk 100 and fastened to the lower shaft 401 through holes 103 to the lower shaft at hole locations 409 by fasteners 405. Also identified is a representative blade assembly comprised of a blade 200 with the blade pivot bearing projections 201 and with the upper pivot bearing 203 and lower pivot bearing 203 and the blade travel limiting follower pins 202 which are retained and allowed to articulate between the upper disk 100 and lower disk 300.

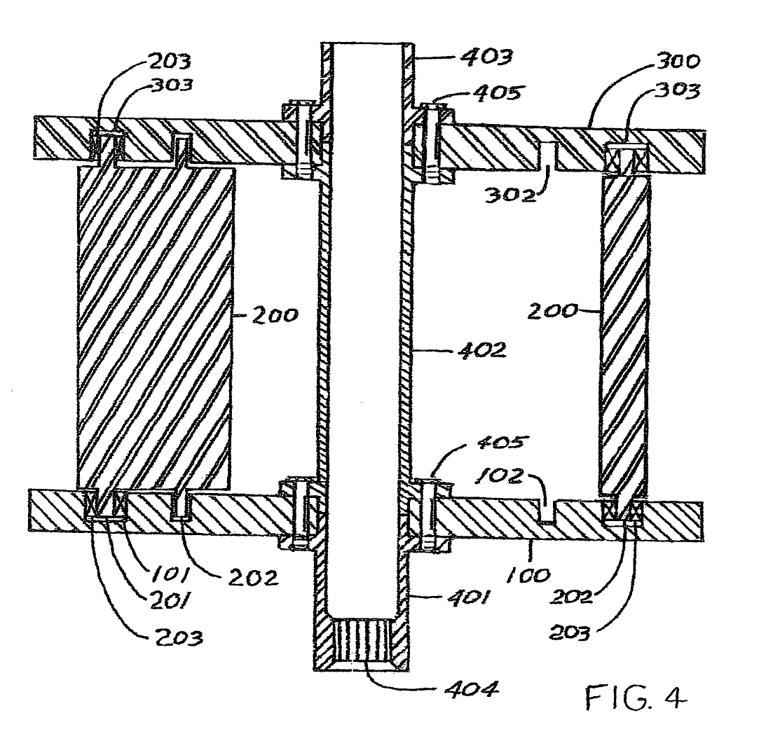

FIG. 4 New) is a vertical cross section through the rotating assembly.

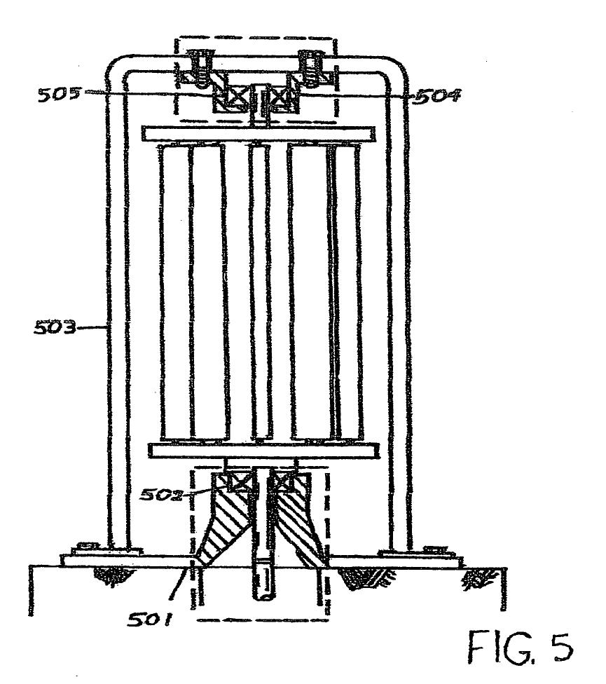

FIG. 5 (New) is a view of the complete assembly from the downwind side of the structure and the blades shown correspond to their location shown on FIG. 2. FIG. 5 shows one method of mounting the assembly of FIG. 2 by a vertical shaft turbine support structure. The rotating assembly is supported at the bottom by a base mounted bearing support 501 containing a bearing 502. Both of these parts are shown in the bottom section view. The design shown on this FIG. 5 can have multiple support legs similar to a birdcage 503. The rotating assembly is supported at the top by a bearing support 504 containing a bearing 505. These parts are shown in the top section.

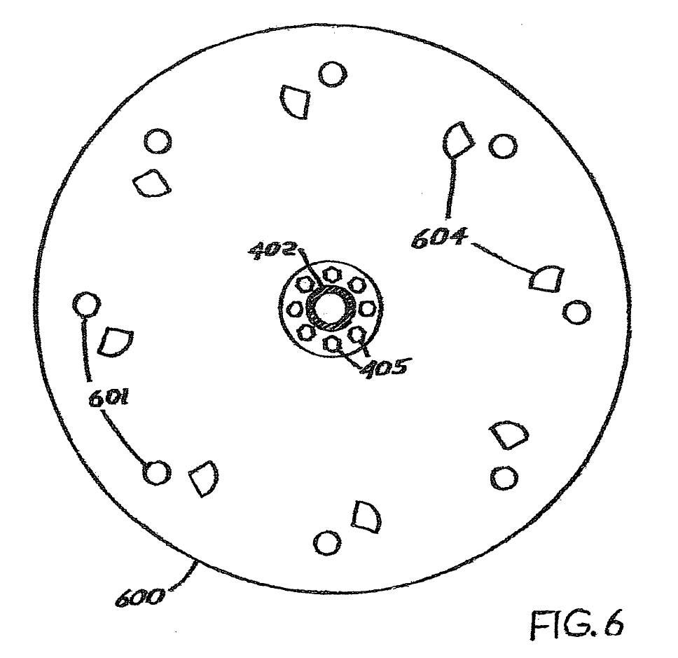

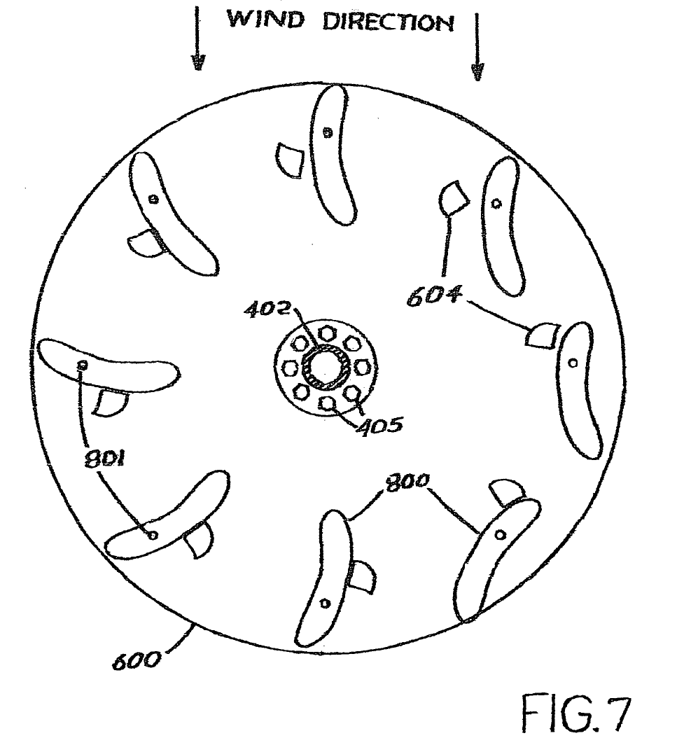

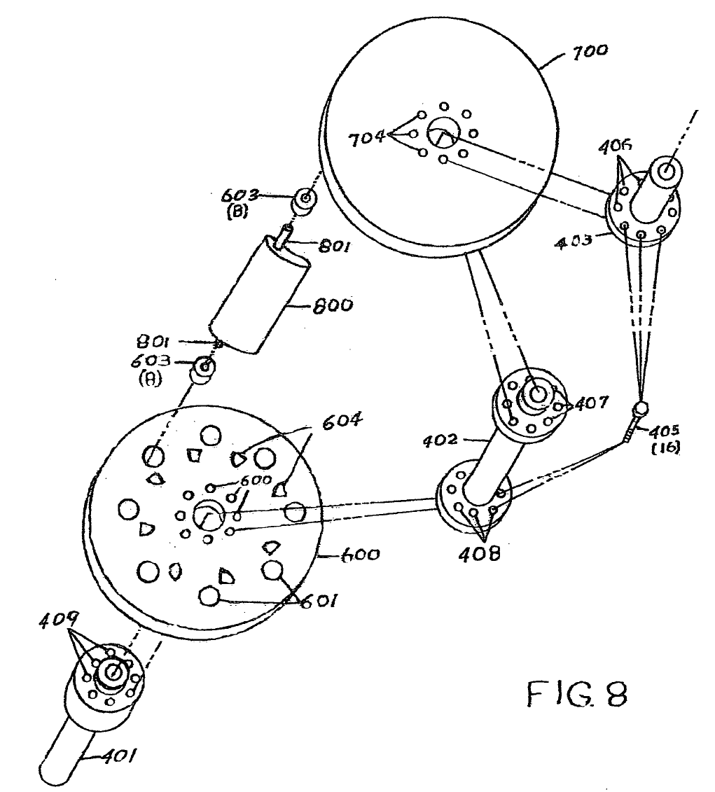

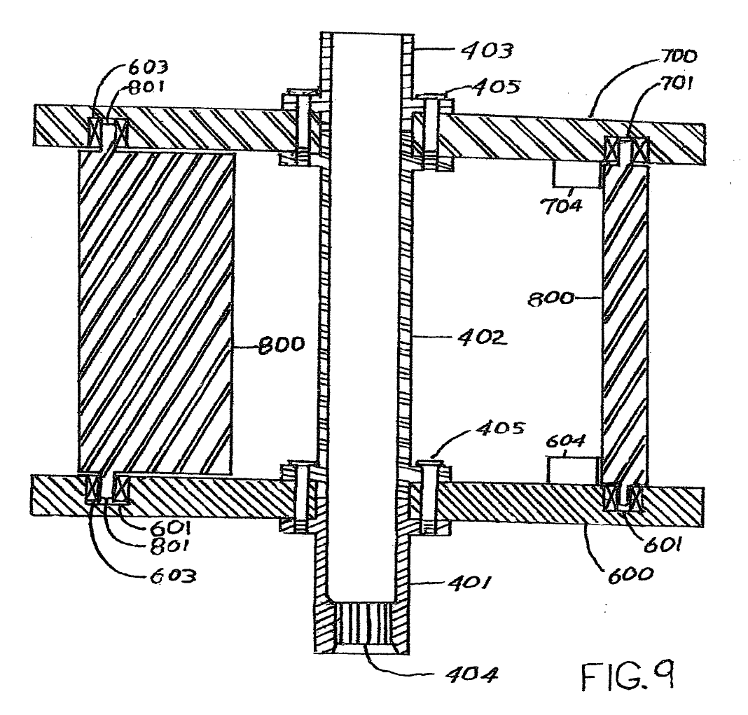

FIG. 6 (New) is a view looking down on the lower disk of the rotating assembly and a blade angle rotation limiter scheme which replaces the blade positioning channels 102 identified in FIG. 1 with fixed protruding blade travel limiting stops 604 mounted on the disk. Illustration on FIG. 6 shows the lower disk 600 which provides recesses 601 to accept the blade pivot bearings 603 and is configured for counter clockwise rotation, however the geometry of the disks and blade of the design could be configured in a mirror image to enable clockwise rotation. In this embodiment the lower disk 600 provides fixed protruding stops 604 to provide blade travel limitation. In the counter clockwise rotation mode the bottom of the upper disk 700 identified in FIG. 8 is the mirror image of all the features indentified in FIG. 7.

FIG. 7 (New) is a view looking down on the lower disk of the rotating assembly with the turbine blades in optimum positioning to yield maximum self regulated output of the turbine and a method using a blade angle rotation limiter scheme which replaces the blade positioning channels 102 in FIG. 1 with fixed protruding blade travel limiting stops mounted on the disk. Illustration on FIG. 7 shows the lower disk 600 provides fixed protruding stops 604 to provide blade travel limitation. FIG. 7 shows blades 800 optimum positioning to yield maximum self regulated output of the turbine. FIG. 7 shows blade pivot bearing projection 801.

FIG. 8 (New) is a view of the individual parts of the rotating assembly utilizing fixed protruding stops 604, The upper shaft 403 is piloted through the upper disk 700 and fastened to the middle shaft 402 through holes 704 to the middle shaft at hole locations 407 by fasteners 405. The middle shaft 402 is piloted through the lower disk 600 and fastened to the lower shaft 401 through holes 606 to the lower shaft at hole locations 409 by fasteners 405. Also identified is a representative blade assembly comprised of a blade 800 with the blade pivot bearing projections 801 and with the upper pivot bearing 603 and lower pivot bearing 603 which are retained and allowed to articulate between the upper disk 700 and lower disk 600.

FIG. 9 (New) is a vertical cross section through the rotating assembly.

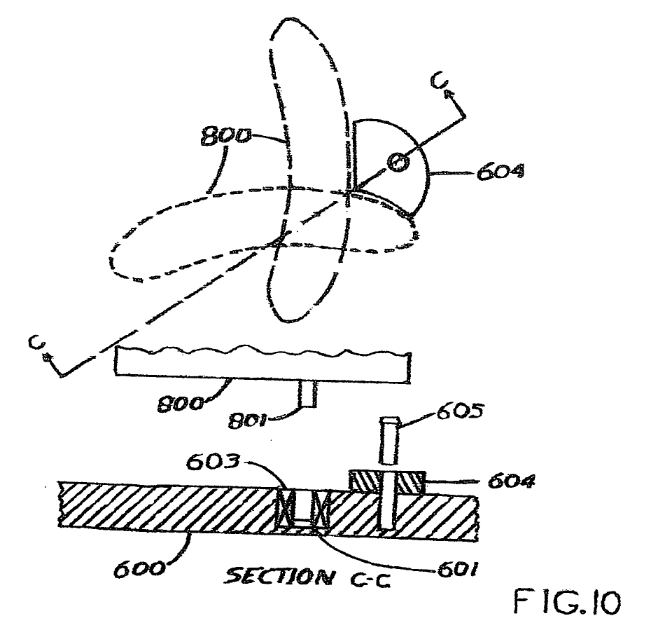

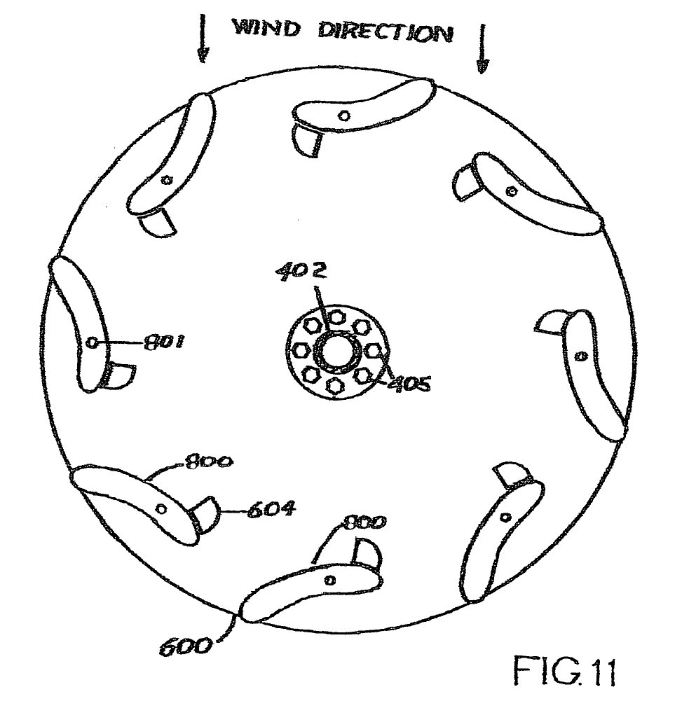

FIG. 10 (New) is a detail drawing of an individual blade 800 with one embodiment of blade travel limitation using fixed protruding stops 604 with one embodiment of a mechanical attachment of the stop 605 for blade travel limitation and a section view of the lower disk 600 that receives the blade.

FIG. 11 (New) is a view looking down on the lower disk 600 of the rotating assembly with the turbine blades 800 self regulating by aerodynamic and centrifugal forces into an over-speed prevention position.

What is claimed is:

1. Wind powered turbine, comprising:
a) a rotating assembly of disks to support blades and drive shaft and
b) a coupling to transmit power by the drive shaft to a device and
c) the configuration of the disks to control the position of the blades and
d) location of mounting devices on the blades to permit self-positioning the blades in response to airflow direction and
e) blade movement allowable by the mounting system allows 90 degree rotation of the blade about its axis and
f) symmetrical aerodynamic configuration of the airfoil about the blade center line and
g) constant cross section of the blade airfoil over the entire length of the blade and
h) low axial and chord wise stress on the blades resulting in low blade failure and
i) is fully scalable in all dimensions to meet varying power needs and
j) is shown as a vertical device works equally well as a horizontal device and
k) material for manufacture would be selected depending upon environment at point of installation

2. Wind turbine disk comprising:
(a) mounts for the blade pivot bearings and
(b) channels to accept the blade travel limiting follower pin enabling up to 90 degrees variation in blade position with respect to the drive shaft and
(c) attachment to a drive shaft and
(d) a mirror image of the configuration provides opposite rotation.

3. A turbine blade configuration comprising:
(a) an airfoil which is a symmetrical about the chord (New corrected spelling) which is an arc and
(b) a common blade cross section for the length of the blade and
(c) locating the axis of blade rotation through a blade pivot bearing(s) positioned away from the centerline of the blade and
(d) a blade travel limiting follower pin which determines the ability of each blade to assume its most effective position.

4. Wind powered turbine, comprising:
a) a rotating assembly of disks to support blades and drive shaft and
b) a coupling to transmit power by the drive shaft to a device and
c) the configuration of the disks to control the position of the blades and
d) location of fixed protruding stops to permit self-positioning the blades in response to airflow direction and
e) blade movement allowed by the travel limiting design allows a wide angle of rotation of the blade about its axis and
f) symmetrical aerodynamic configuration of the airfoil about the blade center line and
g) constant cross section of the blade airfoil over the entire length of the blade and
h) low axial and chord wise stress on the blades resulting in low blade failure and
i) are fully scalable in all dimensions to meet varying power needs
j) is not material sensitive and material for manufacture would be selected depending upon environment at point of installation

5. Wind turbine disk comprising:
(a) mounts for the blade pivot bearings and
(b) fixed protruding stops mounted on the disks of which only one of many possible embodiments is illustrated in the drawings that enable wide swing in blade position with respect to the drive shaft and
(c) attachment to a drive shaft and
(d) a mirror image of the configuration provides opposite rotation and
(e) the disks could also be framework fabrications, stampings or castings configured to reduce cost and weight by applying structural material only in the areas required to support and position the blade bearings and the protruding stops as applicable with respect to the shaft location to enable self regulated blade travel limitation as depicted in the illustrations and
(f) the fixed protruding stop may be of several configurations and materials to simplify manufacturing and attachment to the disk and to mitigate vibration during blade positioning and
(g) the fixed protruding stops which can be configured in a wide variety of shapes, quantities and located and a wide variety of locations any of which enable the blades to swing freely to self regulate themselves to stop in the optimum positions throughout the disk rotation.

6. A turbine blade configuration comprising:
(a) an airfoil which is a symmetrical about the chord which is an arc and
(b) a common blade cross section for the length of the blade and
(c) locating the axis of blade rotation through a blade pivot bearing(s) positioned away from the centerline of the blade and
(d) fixed protruding stops mounted to the disk which determines the ability of each blade to assume its most effective position and
(e) the number, the shape, the length and the chord of the blades can vary depending on the particular application.

7. The design of the blade, the blade mounting system and the blade travel limiting approaches of the fixed protruding stop or the channel and following pin design directs the blades to self regulate by aerodynamic and centrifugal forces into an over-speed prevention position.

8. One entire rotating assembly can be stacked and attached to other entire rotating assemblies and be fully functional generating additional output depending on the particular application.

9. The protruding stops, the follower pins and the channels may have cushions or cushioning material applied to minimize impact stress and vibration where blade travel is limited throughout the disk rotation.
